(19) United States
(12) Patent Application Publication
(10) Pub. No.: US 2015/0342805 A1
(43) Pub. Date: Dec. 3, 2015

(54) MOBILE TRANSPORTATION DEVICE CONVERTIBLE TO A TRENDELENBURG TABLE AND FOR USE IN A MOTOR VEHICLE AND METHOD THEREOF

(71) Applicant: HARRIS MEDICAL, LLC, Hobe Sound, FL (US)

(72) Inventor: Robert M Harris, JR., Hobe Sound, FL (US)

(21) Appl. No.: 14/820,413

(22) Filed: Aug. 6, 2015

Related U.S. Application Data
(63) Continuation-in-part of application No. 14/306,662, filed on Jun. 17, 2014.
(60) Provisional application No. 61/976,953, filed on Apr. 8, 2014.

(51) Int. Cl. A61G 1/02; A61G 7/018; B65G 67/04; A61G 3/08; A61G 7/012; A61G 7/015; A61G 7/005; A61G 7/16

(52) U.S. Cl. CPC A61G 1/0237; A61G 7/005; A61G 7/018; A61G 7/16; A61G 3/0816; A61G 7/012; A61G 7/015; B65G 67/04

(57) ABSTRACT

A mobile transportation device convertible to a Trendelenburg table configured to be transported in a motor vehicle and method thereof, the device comprises a lower base, an upper base, and a scissor lift assembly, the scissor lift assembly is configured to raise and lower the upper base via a hydraulic foot action pump lever, a plurality of tie down links are optionally positioned on the upper frame or the lower frame for securing the transportation device to a motor vehicle.

### CROSS-REFERENCE TO RELATED APPLICATION

The present application is a continuation-in-part of co-pending U.S. application Ser. No. 14/306,662 (the “'662” Application), filed on Jun. 17, 2014, and entitled MOBILE TRANSPORTATION DEVICE CONVERTIBLE TO AN EXAMINATION TABLE AND FOR USE IN A MOTOR VEHICLE AND METHOD THEREOF, which claims the benefit under 35 U.S.C. §119(e) to U.S. Provisional application Ser. No. 61/976,953 (the “'953” Application), filed Apr. 8, 2014, entitled MOBILE TRANSPORTATION DEVICE CONVERTIBLE TO AN EXAMINATION TABLE AND FOR USE IN A MOTOR VEHICLE AND METHOD THEREOF. The '662 and '953 Applications are hereby incorporated herein by reference in their entireties.

### FIELD OF THE INVENTION

The present invention relates to a mobile transportation device, and more in particularly to a mobile transportation device convertible to a Trendelenburg table configured to be transported in a motor vehicle and method thereof.

### BACKGROUND OF THE INVENTION

In the past, patients living in nursing home facilities were relatively difficult to transport between the nursing home and a doctor's office or like medical facility due to their advanced age and conditions. The elderly individuals living in nursing care facilities commonly must be lifted by a worker because these elderly are at advanced stages and cannot stand unassisted. These elderly individuals are regular medical patients and frequently visit doctor's offices and other medical facilities.

One particular problem with the prior art systems and methods for transporting elderly patients between their medical visits is that workers must constantly lift and transfer the elderly patients between a host of different seats, cots, and examination tables.

Accordingly, one or more workers, nurses, and others must transfer the elderly patients to different devices to facilitate a medical appointment or examination, including without limitation dialysis appointments to facilitate increased cardiac filling and prompt increase of blood pressure due to the frequent decrease in blood pressure commonly associated with dialysis.

However, elderly patients are susceptible to skin tears, bruising, and bone fractures. The transfer of elderly patients between different devices, such as wheelchairs and examination tables, significantly increases the aforementioned injuries, particularly for patients in need of dialysis. To make matters worse, elderly patients struggle out of fear of being dropped or the lack of dignity associated with the lack of autonomy and dependency of others.

Over time, workers experience injury due to the constant lifting of elderly patients. Costly workman's compensation claims commonly pay workers for back injuries associated with the constant lifting of the elderly patients.

Resultantly, the nursing homes and medical facilities have previously been left with no viable alternatives for safety transporting patients to a doctor's office, including dialysis appointment, without the need for a significant amount of additional equipment and/or staff to transfer the elderly patient between multiple wheel chairs, motor vehicle seats, and examination and procedure tables, which results in additional costs to both the patients and the medical care facilitites.

Accordingly, a need exists for a single transportation device that is configured to safely transport a patient between a living facility, which includes without limitation nursing homes, assisted living facilities, long term care facilities, or other like facilities, and a medical care facility, which includes without limitation doctor's offices, hospitals, dialysis facilities, or other medical treatment facilities. Furthermore, a need exists for a transportation device that allows for a transition to an examination table for examining of a patient in the Trendelenburg position, supine position and/or semi-supine position, and for other improvements that will become evident as the present invention is described in detail below.

### SUMMARY OF THE INVENTION

The present invention advantageously provides a transportation device convertible to a Trendelenburg table configured to be transported in a motor vehicle and method thereof, including without limitation a method of transport of the device between a first location and a second location.

According to an embodiment of the present invention, a principal object is to provide a device with a seating system configured to transition a person between a seated position and a supine position and/or a Trendelenburg position. The device configured to provide a stable support surface, including a stable seat for a patient, under motor vehicle crash conditions.

According to an embodiment of the present invention, another object is to provide an examination and/or procedure table for a patient thereon in a supine position and/or Trendelenburg position configured to provide a stable support surface under motor vehicle crash conditions.

According to an embodiment of the present invention, another object is to provide a table for examining a person thereon in a Trendelenburg position, supine and/or semi-supine position configured to provide a stable support surface under motor vehicle crash conditions that operatively prevents submarining of the patient thereof.

According to an embodiment of the present invention, another object is to provide a table for examining a person thereon in a Trendelenburg position, supine and/or semi-supine position and further configured to transition into a seated position and provide a stable support surface when the present invention is placed in a seated position under motor vehicle crash conditions that operatively prevents submarining of the patient thereof.

According to an embodiment of the present invention, another object is to provide a table for a person thereon in a Trendelenburg position and/or supine position configured to provide a stable support surface under motor vehicle crash conditions, the table provided with four securement points configured to withstand forces of at least 20 g during a 30 mph crash, the table operatively labeled the four points of securement, the four points of securement being configured to accept tie down members thereof.

According to an embodiment of the present invention, another object is to provide a table for a person thereon in a Trendelenburg position and/or supine position configured to provide a stable support surface under motor vehicle crash conditions, the table including a seat belt, the seat belt having anchor points to receive and couple with a vehicle-anchored shoulder belt.

According to an embodiment of the present invention, another object is to provide for a table that can safely transport a person to and from a patient care facility, such as an assisted living facility, a nursing home facility, a long term care facility, or other like facilities, the table configured to secure within a vehicle using a four point system.

According to an embodiment of the present invention, another object is to provide for a Trendelenburg table that can transition into a wheel chair and can safely transport a person in a seated position to and from a patient care facility, such as an assisted living facility, a nursing home facility, a long term care facility, or other like facilities, the table configured to secure within a vehicle using a four point system.

According to an embodiment of the present invention, another object is to provide a combination Trendelenburg table and wheel chair for examining, dialysis, and/or any other medical procedure, for a person thereon.

According to an embodiment of the present invention, another object is to provide a crash tested Trendelenburg table.

According to an embodiment of the present invention, another object is to provide a wheelchair having a scissor lift assembly having one or more tie-down links for securing the wheelchair to a vehicle via the vehicle's tie-down link system, the wheelchair having a scissor lift assembly, the wheelchair being crash tested and covertable to a Trendelenburg table.

According to an embodiment of the present invention, a transportation device convertible to a table for supporting a person thereon is provided and comprised of a lower support structure, two pairs of rotatable wheels carried by the support structure, an upper support structure coupled with the lower support structure, a lifting structure coupling the upper support structure with the lower support structure, and at least one tie down link secured about the transportation device.

In some embodiments, at least four of the tie down links are provided.

Some embodiments further comprise a back portion pivotably coupled in relation to the upper support structure.

Some embodiments further comprised of a longitudinally extending crash support member removably mountable between a portion of the back portion and the upper support structure.

Some embodiments further comprised of a longitudinally extending crash support member positioned between a portion of the back portion and the upper support structure, such that the crash support member is collapsible when in a table and/or Trendelenburg position. The crash support member locks in extension during transportation when the present invention is in a seated position for support of the back portion during motor vehicle crash conditions.

Some embodiments further comprised of a crash support member positionable for maintaining the back portion in at least a substantially upright position.

Some embodiments comprised of the lifting structure having a scissor lifting portion.

According to an embodiment of the present invention, the scissor lifting portion further comprised of a left outer arm and a left inner arm joined together at an intermediate location, the outer and inner left arms each having a first end and a second end defining four left arm ends, one of the left arm ends pivotably joined with the upper support structure, one of the left arm ends pivotably joined with the lower support structure, one of the left arm ends slidably joined with the lower support structure, one of the left arm ends slidably joined with the upper support structure and a right outer arm and a right inner arm joined together at an intermediate location, the outer and inner right arms each having a first end and a second end defining four right arm ends, one of the right arm ends pivotably joined with the upper support structure, one of the right arm ends pivotably joined with the lower support structure, one of the right arm ends slidably joined with the lower support structure, one of the right arm ends slidably joined with the upper support structure.

In some embodiments, a hydraulic lift assembly is carried by the lower support structure.

In some embodiments, a plurality of posts have proximal ends carried by the lower support structure and have distal ends operable to support the upper support structure.

In some embodiments, the transportation device is constructed to withstand forces of at least 20 g during a 30 mph crash.

In some embodiments, a transportable examination table is comprised of a transportable structure carrying a plurality of wheels and a plurality of tie down links secured about the transportable structure.

In some embodiments, the transportable structure is configured to support a patient in a supine position thereon.

In some embodiments, the transportable structure constructed to withstand forces of at least 20 g during a 30 mph crash.

In some embodiments, the transportable structure is defined having a base defining a lower support structure and an upper support structure, the lower support structure carrying a plurality of wheels, a scissor lifting structure coupling the upper support structure with the lower support structure, a support portion carried by the upper support structure, the support portion defining an upper support portion, a middle support portion, and a lower support portion, the support portion convertible between a Trendelenburg table and a chair, a lap belt carried by the upper support structure at two points horizontally behind the middle support portion, and at least four tie down links secured about the transportable structure.

In some embodiments, the base is constructed to withstand forces of at least 20 g during a 30 mph crash.

In some embodiments, the transportable examination table has a safety arm removably couplable between the base and the support portion.

In some embodiments, a plurality of links are configured to join the lower support structure with the upper support structure when the scissor lifting structure is positioned in a collapsed position.

According to an embodiment of the present invention, a method of transporting a Trendelenburg table between a first location and a second location is provided, the method is comprised of placing the Trendelenburg table in a lowered position, securing the examination table in a motor vehicle via four tie down links, transporting the examination table between the first location and a second location, positioning the examination table between a seated position and a Trendelenburg position, returning the examination table to a seated position, securing the examination table in a motor vehicle via four tie down links, and transporting the examination between the second location and the first location.

In some embodiments, after positioning the examination table between a seated position and a horizontal position is further comprised of the process of allowing the examination of a patient thereon.

In some embodiments, securing an at least partially removable support member with the examination table in the seated position during transportation between the first and second location.

Other objects will become evident as the present invention is described in detail below.

### BRIEF DESCRIPTION OF THE DRAWINGS

Embodiments of the present application are described herein in which similar elements are given similar reference characters, and a more complete understanding of the present invention, and the attendant advantages and features thereof, will be more readily understood by reference to the following detailed description when considered in conjunction with the accompanying drawings wherein:

FIG. 1 is a right side view of a mobile transportation device with the scissor lift assembly lowered in accordance with the principles of the present embodiment;

FIG. 2 is a right side view of the mobile transportation device with the upper base partially raised in relation to the lower base by scissor lift in accordance with the principles of the present embodiment;

FIG. 3 is a right side view of the mobile transportation device placed in an examination table configuration in accordance with the principles of the present embodiment;

FIG. 4 is a perspective view of the left and rear of the mobile transportation device fully raised via a lift assembly in accordance with the principles of the present embodiment;

FIG. 5 is an enlarged partial view of the right side of the mobile transportation device with the scissor lift assembly lowered in accordance with the principles of the present embodiment;

FIG. 6 is an enlarged partial view of the right side of the mobile transportation device with the scissor lift assembly raised in accordance with the principles of the present embodiment;

FIG. 7 is an enlarged partial view of a lower right track in accordance with the principles of the present embodiment;

FIG. 8 is partial view of the rear of the mobile transportation device having an optional removable safety bar in accordance with the principles of the present embodiment;

FIG. 9 is a partial view of the hydraulic lift assembly in accordance with the principles of the present embodiment;

FIG. 10 is a block diagram of an exemplary method for transporting a mobile transportation device;

FIG. 11 is a left side view of a mobile transportation device with the scissor lift assembly lowered and configured to transition to a Trendelenburg table in accordance with the principles of the present embodiment;

FIG. 12A is a perspective left side view of a mobile transportation device positioned into a Trendelenburg table in accordance with the principles of the present embodiment;

FIG. 12B is a perspective left side view of a mobile transportation device positioned into a Trendelenburg table with the Trendelenburg frame exposed in accordance with the principles of the present embodiment;

FIG. 13 is a partial left side perspective view of a mobile transportation device of FIG. 11 depicting a pin for locking and unlocking a Trendelenburg frame portion in accordance with the principles of the present embodiment; and

FIG. 14 is a rear perspective view of a mobile transportation device in accordance with the principles of the present invention.

### DETAILED DESCRIPTION OF THE INVENTION

The present invention relates to a mobile transportation device, and more in particularly to a mobile transportation device convertible to an examination table configured to be transported in a motor vehicle and method thereof.

Accordingly, the device and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

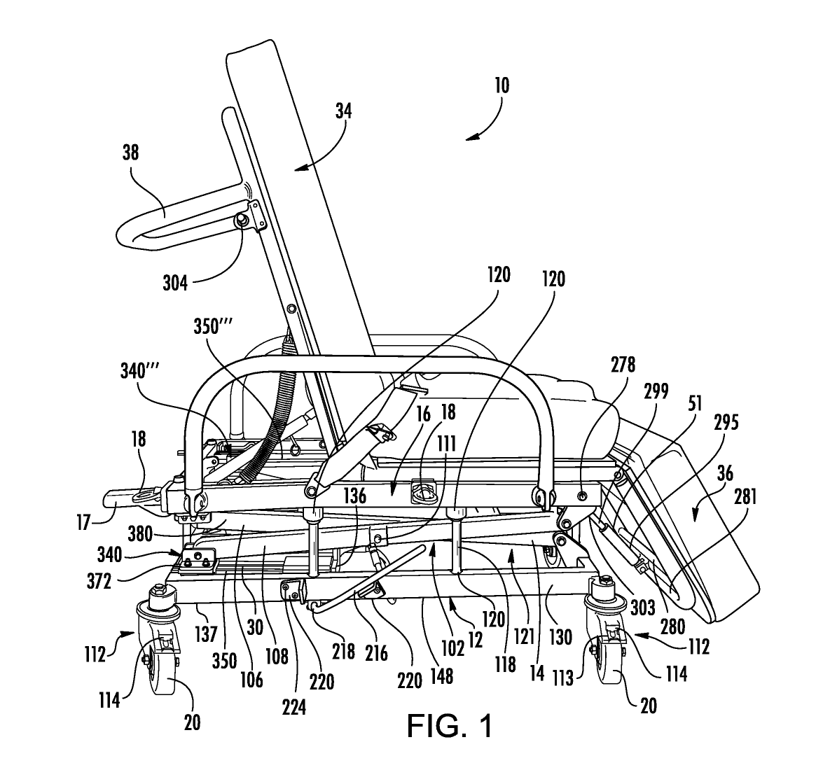

Referring now to the drawing figures in which like reference designators refer to like elements. FIGS. 1-9 show an exemplary mobile transportation device convertible to an examination table configured to be transported in a motor vehicle and method thereof, the mobile transportation device constructed in accordance with the principles of the present invention and designated generally as mobile transportation device 10.

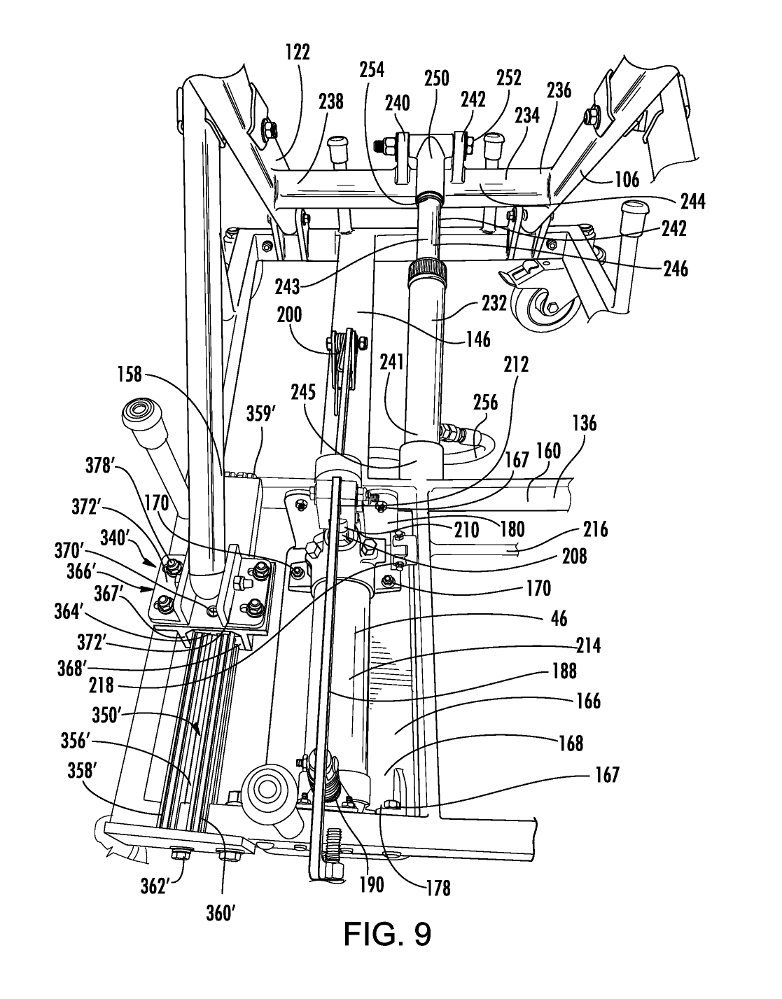

Referring now to FIG. 1, device 10 comprises a lower base 12, an upper base 16, and a scissor lift assembly 121. The lower base 12 carries the scissor lift assembly 121 and the upper base 16. The scissor lift assembly 121 has a scissor lift portion 14 configured to raise and lower an upper base 16 via a hydraulic foot action pump lever 17 that controls a hydraulic pump 46, the hydraulic pump best shown in FIG. 9.

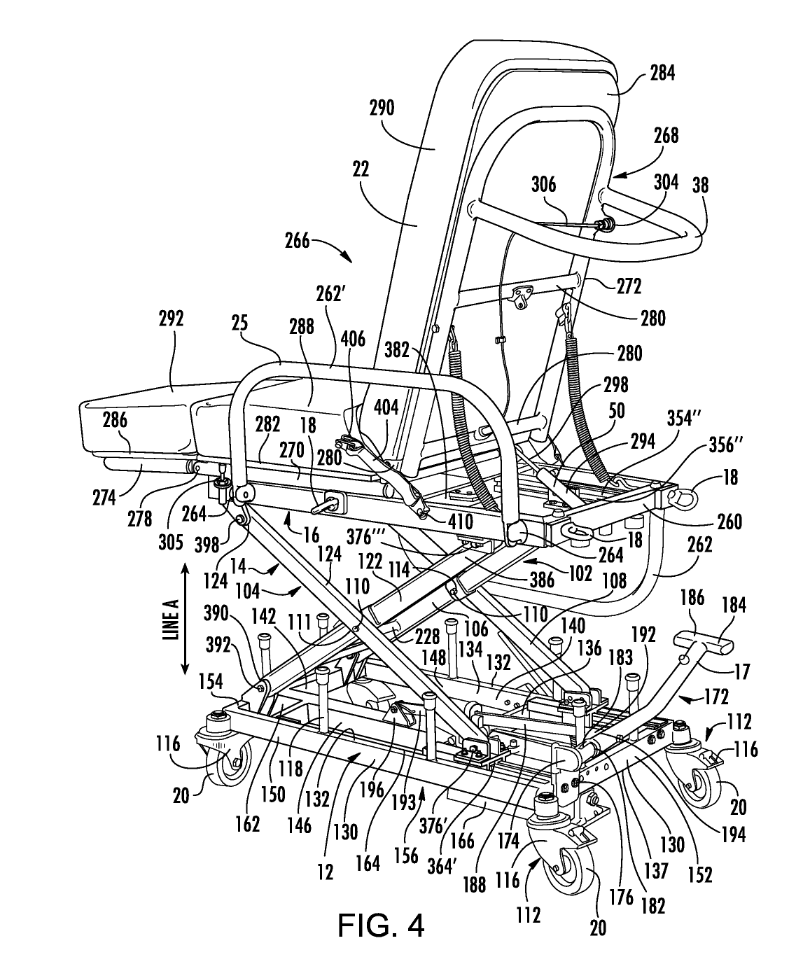

The scissor lift portion 14 includes a right side 102 (FIG. 1) and a left side 104 (FIG. 4). In an embodiment, the right side 102 and the left side 104 are in parallel to each other. The right side 102 and the left side 104, each have one or more inner arms 106, 122 and one or more outer arms 108, 124, as best illustrated by the combination of FIGS. 1, 4. In the embodiment shown in FIG. 1, the right side 102 includes right outer arm 108 and right inner arm 106. In the embodiment shown in FIG. 4, the left side 104 includes left outer arm 124 and left inner arm 122. The one or more left side arms 122, 124 move in unison with the right side arms 106, 108.

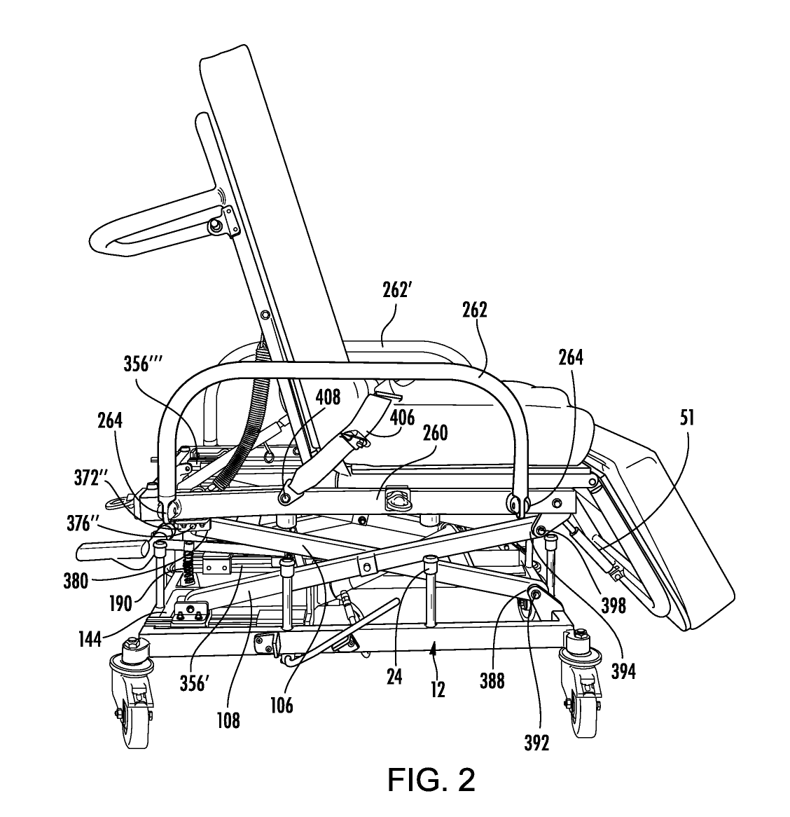

In an embodiment, the arms 106, 108, and 122, 124 are constructed as parallelograms (See FIGS. 2-4) in relation between the right side 102 and left side 104. The inner arms 106, 122 and the outer arms 108, 124 for each side are connected together at an intermediate axis 110 (See FIG. 4). Fastening pins 111 join the arms 106, 108 and 122, 124 together, respectively. In an embodiment, the fastening pin 111 extends through an aperture on the inner arms and outer arms 106, 108 and 122, 124 for each side. In one example, a retaining member 114 is included on a first end of the fastening pin 112 and a retaining member 114 is included on a second end of the fastening pin 112. The retaining member may include a retaining head, a retaining pin, a threaded retaining bolt, or any member configured to retain the fastening the pin joining any of the arms together. In an embodiment, the retaining members 114 are affixed, such as by way of welding, bolting, or the like.

While the instant invention is shown having a single scissor lift portion 14, it is within the scope of the invention to provide the existing scissor lift portion 14 with a scissor assembly having four or more criss-crossing arms on each of at least two sides the invention creating a pantograph lifting portion.

In an embodiment, it should be appreciated that the right side 102 and the left side 104 are generally mirror images of each other for reference purposes.

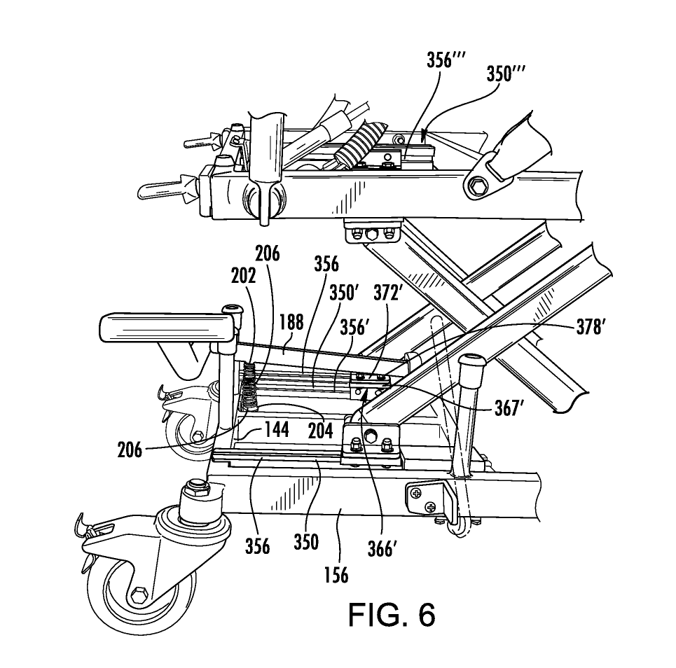

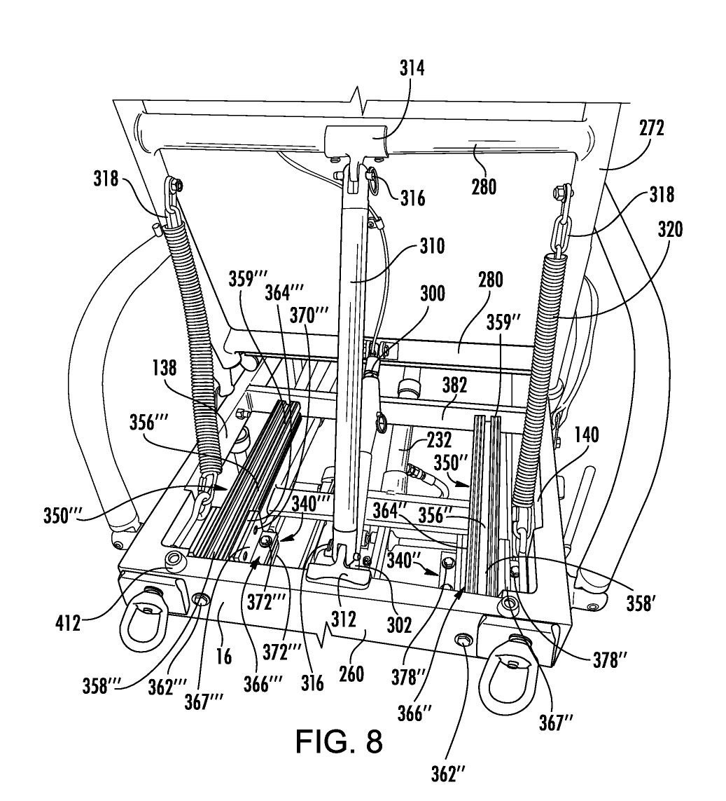

As best illustrated by FIGS. 1, 4, 6, 7, a track assembly 330 is shown, the track assembly 330 comprises a plurality of at least nearly identical tracks 350, 350′, 350″, 350′″ and at least nearly identical slide assemblies 340, 340′, 340″, 340′″, each orientated and positioned about the lower base 12 or the upper base 16 as necessary to allow the upper base 16 to be hydraulically raised and lowered in relation to the lower base 12. In the embodiment best illustrated by FIG. 6, two lower tracks 350, 350′ are secured with the lower base 12. In the embodiment best illustrated by FIG. 8, the two upper tracks 350″, 350′″ are secured with the upper base 16.

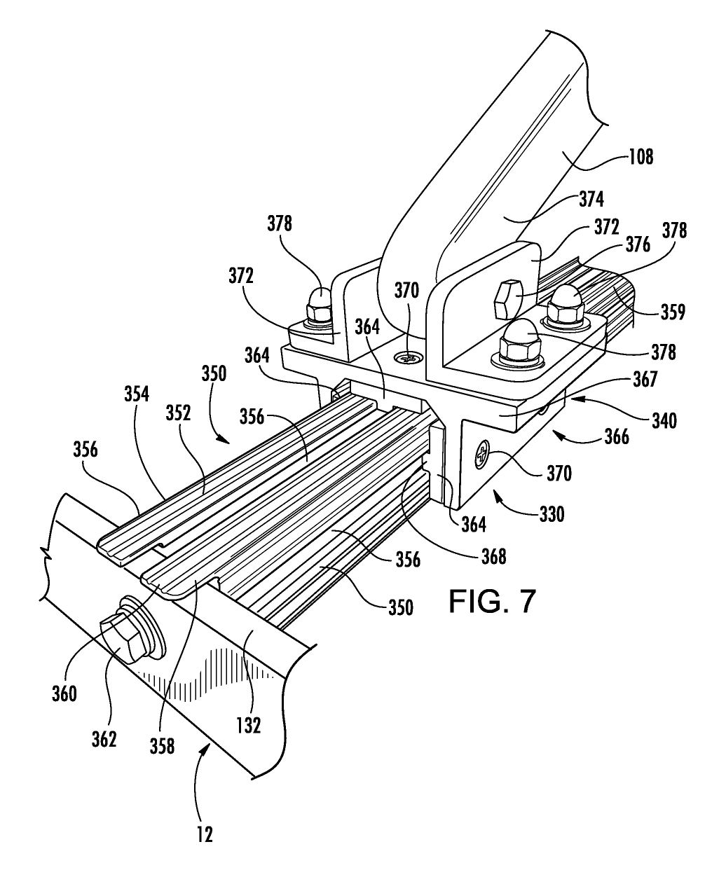

When referring to FIG. 7, it would be appreciated and understood the features of the track 350 and the slide assembly 340 are nearly identical to the other tracks 350′, 350″, 350′″ and slide assemblies 340′, 340″, 340″, but are orientated and disposed at different locations about the device 10.

The track 350 includes at least a flat upper surface 351 and at least two flat side surfaces 352, 354, extending out parallel to the flat upper surface 352. The surfaces 351, 352, 354 each including at least one groove 356. While the track(s) 350 is shown as being substantially rectangular, other shapes and configurations may be implemented within the spirit and scope of the present invention, such a triangular, cylindrical, or the like.

Still referring to FIG. 7, the track 350 includes a first end 358 that includes a lip 360 and a second end 359. The lip 360 disposed substantially against an upper surface 132. The track 350 is secured on the first end 358 with the lower base 12. The second end 359 is secured with the cross-support beam 136 (FIG. 1). A bolt 362 traverses the lower base 12 for securing the track 350 to the lower base 12. The slide assembly 340 surrounding and/or encompassing at least a portion of the track 350 (The slide assembly 340 illustrated in FIG. 7 encompassing three sides of the track 350). The slide assembly 340 comprises a slide bracket assembly 366 configured to slide along the track 350. The slide bracket assembly 366 comprises a main portion 367 and one or more arm mounts 372, the one or more arm mounts 372 joined with the main portion 367 via one or more bolts 378. The slide bracket assembly 366 maintains one or more slide members 364 (The slide assembly 340 of the present invention has three slide members 364, each slide member 364 engaging a side of the track 350). The slide members 364 each have at least one tooth 368 that reciprocates with a groove 356 for gripping the track 350 and otherwise maintaining a connection between the slide assembly 340 and the track 350. The slide members 364 secured to the slide bracket 366 via one or more screws 370, bolts, welding, or the like. The slide bracket 366 comprising arm mounts 372 for pivotably joining with one of the inner or outer arms. The instant embodiment illustrates two arm mounts 372 pivotably joining with a lower end 374 of the right outer arm 108 via a pin 376.

Referring now to FIGS. 2, 4, 6, 9, the track 350′ includes a first end 358′ that includes a lip 360′ and a second end 359′. The lip 360′ disposed substantially against an upper surface 132. The track 350′ is secured on the first end 358′ with the lower base 12 and is secured at the second end 359′ with the cross-support beam 136. A bolt 362′ traverses the lower base 12 for securing the track 50 to the lower base 12. The slide assembly 340′ surrounding and/or encompassing at least a portion of the track 350′. The slide assembly 340′ comprises a slide bracket assembly 366′. The slide bracket assembly 366′ comprises a main portion 367′ and one or more arm mounts 372′, the one or more arm mounts 372′ joined with the main portion 367′ via one or more bolts 378′. The slide bracket assembly 366′ maintains one or more slide members 364′ (The slide assembly 340′ of the present invention has three slide members 364′). The slide members 364′ each have at least one tooth 368′ that reciprocates with a groove 356′ for gripping the track 350′ and otherwise maintaining a connection between the slide assembly 340′ and the track 350′. The slide members 364′ are secured to the slide bracket 366′ via one or more screws 370′, bolts, welding, or the like. The slide bracket 366′ comprised of arm mounts 372′ for pivotably joining with one of the inner or outer arms. The instant embodiment illustrates two arm mounts 372′ pivotably joining with a lower end 374 of the left outer arm 124 via a pin 376′.

Referring now to FIGS. 2, 4, 5, 8, the track 350″ includes a first end 358″ that includes a lip 360″ and a second end 359″. The lip 360″ disposed substantially against a lower surface of the upper base 16. The track 350″ is secured on the first end 358″ with the upper base 16 and is secured at the second end 359″ with the upper base cross-support beam 382. A bolt 362″ traverses the upper base 16 for securing the track 50″ to the upper base 16. The slide assembly 340″ surrounding and/or encompassing at least a portion of the track 350″. The slide assembly 340″ comprises a slide bracket assembly 366″. The slide bracket assembly 366″ comprises a main portion 367″ and one or more arm mounts 372″, the one or more arm mounts 372″ joined with the main portion 367″ via one or more bolts 378″. The slide bracket assembly 366″ maintains one or more slide members 364″ (The slide assembly 340″ of the present invention has three slide members 364″). The slide members 364″ each have at least one tooth 368″ that reciprocates with a groove 356″ for gripping the track 350″ and otherwise maintaining a connection between the slide assembly 340″ and the track 350″. The slide members 364″ secured to the slide bracket 366″ via one or more screws 370″, bolts, welding, or the like. The slide bracket 366″ comprised of arm mounts 372″ for pivotably joining with one of the inner or outer arms. The instant embodiment illustrates two arm mounts 372″ pivotably joining with an upper end 380 of the right inner arm 106 via a pin 376″.

Referring now to FIGS. 1, 2, 6, 8, the track 350′″ includes a first end 358′″ that includes a lip 360′″ and a second end 359′″. The lip 360′″ disposed substantially against a lower surface of the upper base 16. The track 350′″ is secured on the first end 358′″ with the upper base 16 and is secured at the second end 359′″ with the upper base cross-support beam 382. A bolt 362′″ traverses the upper base 16 for securing the track 350′″ to the upper base 16. The slide assembly 340′″ surrounding and/or encompassing at least a portion of the track 350′″. The slide assembly 340′″ comprises a slide bracket assembly 366′″. The slide bracket assembly 366′″ comprises a main portion 367′″ and one or more arm mounts 372′″, the one or more arm mounts 372′″ joined with the main portion 367′″ via one or more bolts 378′″. The slide bracket assembly 366′″ maintains one or more slide members 364′″ (The slide assembly 340′″ of the present invention has three slide members 364′″). The slide members 364′″ each have at least one tooth 368′″ that reciprocates with a groove 356′″ for gripping the track 350′″ and otherwise maintaining a connection between the slide assembly 340′″ and the track 350′″. The slide members 364′″ secured to the slide bracket 366′″ via one or more screws 370′″, bolts, welding, or the like. The slide bracket 366′″ comprised of arm mounts 372′″ for pivotably joining with one of the inner or outer arms. The instant embodiment illustrates two arm mounts 372′″ pivotably joining with an upper end 386 of the left inner arm 122 via a pin 376′″.

The right and left inner arms 106, 122 pivotably joined at lower ends 388, 390, respectively with the lower base 12 via traverse pins 392 (See FIGS. 2 & 4). The right and left outer arms 108, 124 pivotably joined at upper ends 394, 396, respectively, with the upper base 16 via traverse pins 398.

Referring now to FIG. 4, the lower base 12 comprises longitudinally extending frame members 148, 150 connected with latitudinal frame members 152, 154 to form a rectangular frame 156. The rectangular frame 156 has an outer surface 130, an inner surface 134, an upper surface 132, and a lower surface 137.

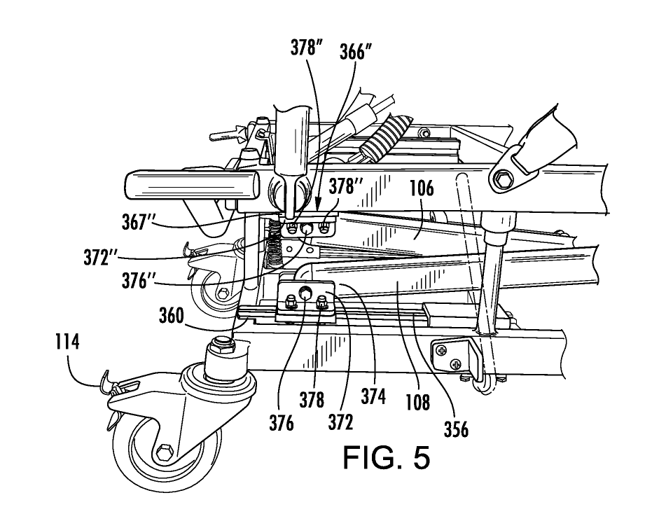

The lower base 12 further carries a plurality of wheel assemblies 112 about the outer surface 130, each wheel assembly has a wheel 20. The wheel assemblies 112 may be formed of a caster wheel assembly. In an embodiment, the wheel assemblies 112 are secured about the corners of, or otherwise carried by, the lower base 12. One or more of the wheel assemblies 112 each optionally include a locking mechanism 113 with a movable locking member 114, which is best illustrated by FIGS. 4 & 5 (FIG. 5 showing the movable locking member 114 in a locked position). The locking member 114 transitions between a locked position and an unlocked position for locking and unlocking the associated wheel 20 from rotating about a wheel bracket 116.

Referring now to FIGS. 1 & 4, the lower base 12 includes a plurality of posts 118 having proximal ends secured to the upper surface 132 of the lower base 12. The plurality of posts 118 extending upwards from the lower base 12 towards the upper base 16. A plurality of protective caps 24, such as a caps formed of rubber or plastic, cover the distal ends of the plurality of posts 118. Optionally, the upper base 16 includes a plurality of reciprocating cups 120, the reciprocating cups have a receiving cavity configured to receive the protective caps 24 when the upper base 16 is placed into a lowered position. In one embodiment, one or more posts 118 contact and/or support the upper base 16 in a lowered position.

As best illustrated in FIG. 1, the upper base 16 in a lowered position rests on posts 118 thereby reducing or otherwise eliminating forces to the scissor lift assembly 121. The upper base 16 against the posts 118 places the force of the upper base 16 and any weight carried by the upper base 16 against the posts 118, operating to extend the life of the scissor lift assembly 121. When in a lowered position, the posts 118 operate to maintain the structural integrity of the device 10 in a motor vehicle accident.

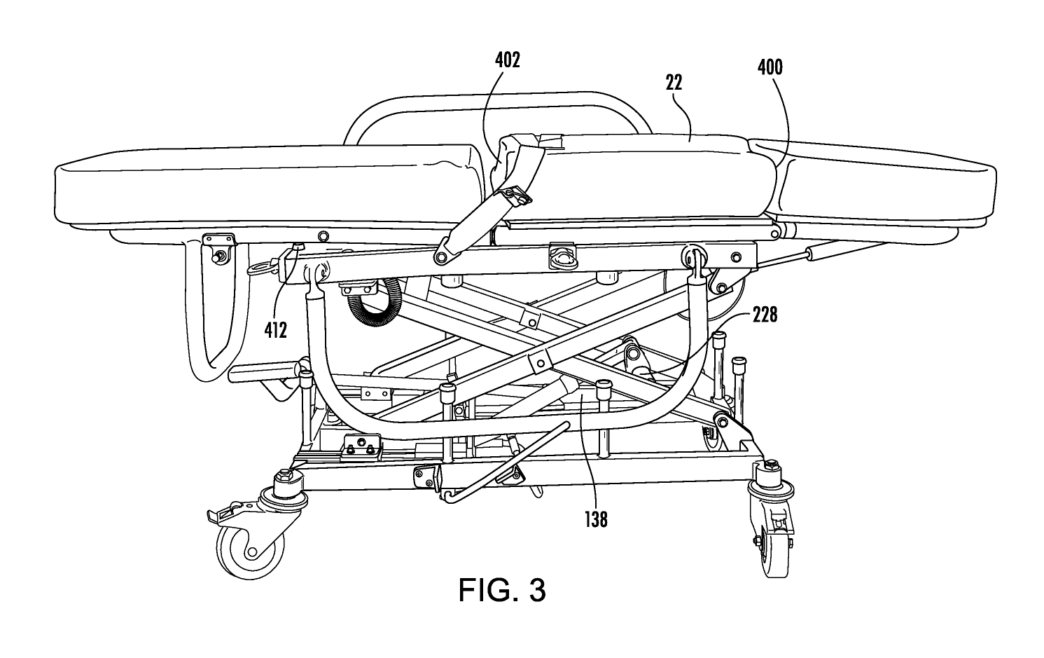

The inner surface 134 has a left portion 138 (FIG. 3), a right portion 140 (FIG. 4), a front portion 142 (FIG. 4), and a rear portion 144 (FIG. 2). The lower base 12 carries a lower cross-support beam 136 (FIGS. 1, 4, and 8). The lower cross-support beam 136 has two ends, the cross-support beam 136 disposed on its first end 158 with the left portion 138 and disposed on its second end 160 with the right portion 140 (FIGS. 1 & 9). The lower base carries a lower base longitudinal beam 146 (FIG. 4). The lower base longitudinal beam 1046 has two ends, the longitudinal beam 146 disposed on its first end 162 with the front portion 142 and disposed on its second end 164 with the cross-support beam 136 (FIG. 4).

Referring now to FIG. 9, a pump bracket 166 has two ends, the pump bracket 166 disposed on a first end 178 with the cross-support beam 136 and disposed on a second end 180 with the latitudinal frame member 152. In the embodiment shown in FIG. 4, the pump bracket 166 is bolted via one or more bolts 167 into place substantially against the cross-support beam 136 and the latitudinal frame member 152. Nevertheless, the pump bracket 166 may be mounted by other means commonly understood to skilled artisans, such as welding. The pump bracket 166 comprises a u-shape portion with an upward facing surface 168 configured to carry the hydraulic pump 46 (FIG. 9). The hydraulic pump 46 is engaged with the pump bracket 166. In an embodiment, the hydraulic pump 46 mounts against the upward facing surface 168 via one or more threaded bolts 170.

Referring again to FIG. 4, an embodiment of a foot action pump assembly 172 is shown. The foot action pump assembly 172 comprises a foot action pump lever 17 and a base member 174. The base member 174 carried by the rectangular frame 156. In an embodiment, the base member 174 is mounted against the latitudinal frame member 152, the base member 174 mounted via one or more bolts 176. The foot action pump lever is pivotably coupled on a proximal end 182 with the base member 174 at a pivot portion. The foot action pump lever further includes a distal end 184 with an optionally perpendicular foot receiving surface 186 for receiving a person's foot for pumping the hydraulic pump 46. The foot action pump assembly further comprises 172 a rocker arm 188 (See FIG. 4) and a spring member 190 (See FIGS. 2 & 9). The rocker arm 188 having a first end 192 and a second end 193, the rocker arm 188 coupled on the first end 192 at an intermediate position 194 along the foot action pump lever 17, the rocker arm 188 pivotably coupled on the second end 193 with the lower base longitudinal beam 146, best illustrated by FIG. 4. A rocker arm pivot bracket 196 interposed between the second end 193 of the rocker arm 188 and the lower base longitudinal beam 146, best illustrated by FIG. 4. The rocker bracket 196 (See FIG. 4) optionally is provided with a spring 200 (See FIG. 9) serving to aid the return of the rocker arm 188 to a neutral position.

Referring now to FIGS. 2, 6, 9, the spring member 190 is held between a portion of the rocker arm 188 and the rectangular frame 156 for returning the rocker arm 188 to the neutral position. In operation, the user will force the lever and the rocker arm downwards, causing the lever 17 to pivot about the pivot portion 183 (See FIG. 4). The spring member 190 includes an upper vertical end 202 and a lower vertical end 204 (See FIG. 6). In one embodiment, the upper vertical end 202 is coupled with a downward extending portion 206 of the rocker arm 188, the lower vertical end 204 is coupled with the rectangular frame 156, best illustrated by FIG. 6. A spring mount 206 is carried by the rectangular frame 156. The spring mount 206 optionally has an upward extending portion that maintains the lower vertical end 204 with the rectangular frame 156. Operatively, downward pivotal movement of the lever 17 causes the spring member 190 to deform into a compressed state, the compression thereof creates potential energy for returning the lever 17 into a neutral position (FIG. 6 illustrates the lever 17 in a neutral position).

Referring again to FIG. 9, the hydraulic pump 46 is provided with a piston 208. The piston has a head 210 operatively coupled at an intermediate position 212 along the rocker arm 188. The lever 17 operatively drives the piston 208 of the hydraulic pump 46 for creating ingress of a hydraulic fluid into the pump cylinder 214, as would be understood by a skilled artisan.

The hydraulic pump 46 is provided with a rotatable bleed valve 212, the rotatable bleed valve allows for egress of hydraulic fluid from the pump cylinder 214 in rotation thereof.

The rotatable bleed valve 212 coupled in rotation with a bleed valve lever 216. The bleed valve lever 216 has a portion thereof extending perpendicular to the pump cylinder 214 to a curved portion of the bleed valve lever 216 curved at element 218, and the bleed valve lever 216 further extending outward from element 218, as illustrated by the combination of FIGS. 1 and 9.

In an embodiment, the rectangular frame 156 carries one or more bleed valve lever stoppers 220, 222 (See FIG. 1). The one or more bleed valve lever stoppers 220, 222 inhibit the bleed valve lever 216 from over rotating the rotatable bleed valve 212. The bleed valve lever stoppers 220, 222 may be mounted to the rectangular frame 156 by any available members, including without limitation bolts 224, welding, or the like.

Still referring to FIG. 9, a latitudinal inner arm beam 234 is provided having a first end 236 and a second end 238. The first end 236 joined with the inner arm 106 and the second end 238 joined with the inner arm 122.

As further shown in at least FIG. 9, the device 10 is provided with a slave cylinder 232 provided with a cylinder arm 246, the slave cylinder 232 has a first end 241 coupled with the cross-support beam 136 and having a second end 243 pivotably coupled with the latitudinal inner arm beam 234. In the instant embodiment, a slave cylinder receiving portion 245 provided with a cavity receives the slave cylinder 232 therein. The slave cylinder receiving portion 245 is joined with the cross-support beam 136 by welding, bolts, or the like. In one embodiment, the slave cylinder 232 is pivotably coupled with the cross-support beam 136. The slave cylinder 232 pivotably coupled with the latitudinal inner arm beam 234. The latitudinal inner arm beam 234 is provided with two leg portions 240, 242 that extend out from the surface 244 thereof.

In an embodiment, an intermediate connection member 250 and a retaining pin 252 couple the slave cylinder 232 with the latitudinal inner arm beam 234. The retaining pin 252 traverses an aperture in each of the connection member 250 and the two leg portions 240, 242 for retaining the connection member 250 with the leg portions 240, 242. A distal portion 254 of the cylinder arm 246 enters a cavity of the connection member 250 retaining the distal end of the cylinder arm 246. The distal portion 254 of the cylinder arm 246 optionally welded with the connection member 250 for creation of a permanent attachment therebetween.

A hydraulic hose 256 is interposed between the hydraulic pump 46 and the slave cylinder 232 for sharing or otherwise transporting hydraulic fluid therebetween for facilitating lifting and lowering of the upper base 16.

In an embodiment, the upper base 16 forms an upper rectangular frame 260 (See FIG. 4) that supports at least a support assembly 266 configured to support a person.

In one embodiment best illustrated by FIG. 4, the support assembly 266 comprises a support frame 268. The support frame includes central frame portion 270, an upper frame portion 272, and a lower frame portion 274. The central frame portion 270 is mounted to the upper base 16. The upper frame portion 272 is pivotably joined with the central frame portion 270 at one or more joints 280. The lower frame portion 274 pivotably joined with the central frame portion 270 at one or more joints 278. The frame includes one or more latitudinal support members 280 for increasing the integrity of the support frame 268. The support assembly further comprises a central cushion support platform 282, an upper cushion support platform 284, and a lower cushion support platform 286 each for supporting a cushion. The central cushion support platform 282 carries a central cushion 288 configured to support a person there against, the person either sitting or in a supine position or semi-supine position. The upper cushion support platform 284 carries an upper cushion 290 configured to support the back of a person there against. The lower cushion support platform 286 carries a lower cushion 292 configured to support the legs of a person there against.

In an embodiment, the upper frame portion 272 includes a handle 38 for grasping. Operatively, the handle 38 may be grasped by a person for pushing the device 10 about its wheels 20.

The device 10 further carries an upper frame gas shock assembly 50. The gas shock assembly 50 comprises a cylinder 294 and an extendable spring piston rod 298. As shown in FIGS. 4 & 8, a first end 300 of the gas shock assembly 50 is pivotably coupled with one of the latitudinal support members 280 and a second end 302 of the gas shock assembly 302 is pivotably coupled with the upper base 16. A valve control member 304 is secured with the upper frame portion 272. A valve control line 306 is interposed between the valve control member 304 and the gas shock assembly 50. The valve control member 304 is a depressible button for allowing adjusting the position of the extendable spring piston rod 298, thereby adjusting the position of the upper frame 272 in relation to the central frame portion 270. Operatively, the valve control member 305 is pushed in a first direction to allow for a hydraulic and/or gas shock assembly 51 to slideably move for positioning the back portion 34. In an alternative embodiment (not shown), the valve control member 304 resembles a bicycle hand bake and optionally is carried by the handle 38.

Referring now to FIG. 8, device 10 includes a removable crash safety bar 310. A first crash safety bar coupler 312 is secured with the upper base 16 and a second crash safety bar coupler 314 is secured with the upper frame portion 272. The crash safety bar 310 is removably joined with the upper base 16 and the upper frame portion 272 by way of the first and second crash safety bar couplers 312, 314. One or more traverse pins 316 pass through apertures on the safety bar 310 and the crash safety bar couplers 312, 314 for removably securing the crash safety bar 310 to the device 10. Optionally, the crash safety bar 310 is operatively positioned to prevent the back portion 34 from reclining and/or inclining during a traffic accident.

Still referring to FIG. 8, an upper base cross-support beam 382 is provided having two ends, the cross-support beam 382 disposed on its first end and second end with the upper base 16.

In an embodiment, device 10 includes one or more safety chains 318 that secure between the upper base 16 and the upper frame portion 272. In yet another embodiment, the one or more safety chains 318 are covered with a member 320, member 320 may be formed of plastic, rubber, or other materials configured to limit direct contact with the one or more safety chains 318. In one operative embodiment, the one or more safety chains prevent over inclination of the back portion 34 during a traffic accident.

As shown in FIG. 1, the device 10 further carries a lower frame gas shock assembly 51. The gas shock assembly 51 comprises a cylinder 295 and an extendable spring piston rod 299. A first end 301 of the gas shock assembly 51 is pivotably coupled with one of the latitudinal support members 281 and a second end 303 of the gas shock assembly 303 is pivotably coupled with the upper base 16. A valve control member 305 (See FIG. 4) is secured with upper base 16. A valve control line not shown) is interposed between the valve control member 305 and the gas shock assembly 51. The valve control member 305 is depressed by a person for adjusting the position of the extendable spring piston rod 299, thereby adjusting the position of the lower frame portion 274 in relation to the central frame portion 270. Operatively, the valve control member 305 is pushed in a first direction to allow for a hydraulic and/or gas shock assembly 51 to slideably move for positioning the leg portion 36. In an alternative embodiment (not shown) the valve control member 305 may resemble a bicycle hand brake

Referring now to FIG. 2, the upper rectangular frame 260 carries rails 262, 262′ and/or guards, on each of the right and left side of the device 10 respectively. One or more rail joints 264 are secured about the rectangular frame 260 for pivotably coupling the rails 262, 262′ to the rectangular frame 260. Operatively, the rails 262, 262′ pivot at least 180 degrees between an engaged position and a disengaged position (FIG. 4 illustrates a left rail 262′ in an engaged position and a right rail 262 in a disengaged position). Operatively, the user can lift the rails 262, 262′ at least slightly upwards, which releases the rails from the engaged position for pivoting the rails to the 180 degree disengaged position.

The upper base 16 carries tie down links 18, the tie down links couple with tie down members (not shown) for securing the device 10 in and to the motor vehicle. The tie down members may include ratchet tie downs as is commonly understood. In an embodiment, two rear tie down links 18 are secured at the rear of the device 10. The two rear tie down links 18 are carried by the upper base 16. Two side tie down links 18 are carried by the device 10. In a particular configuration, the two side tie down links 18 are carried on upper base 16. The tie down links extend out laterally from the upper base 16.

In one embodiment, the side tie down links are disposed against the upper base 16 between a front edge 400 and a rear edge 402 of the central seat cushion 288, as illustrated in FIG. 3.

In one embodiment, the side tie down links 18 are disposed against the upper base 16 at least slightly forward of the upper cushion 290, the upper cushion 290 configured to receives a person's back thereon.

In one embodiment, four tie down links 18 are placed about the device 10, as best illustrated by FIGS. 1 & 4. The four tie down links 18 are placed about the upper base 16, the four tie down links 18 configured to receive tie down straps for securing the device 10 in a vehicle. In one non-exclusive embodiment, the device 10 is secured in a seated upright position and the scissor lift assembly 121 in a lowered configuration as best illustrated by FIG. 1 (the tie down straps are not shown).

In an embodiment, the device 10 carries a two point pelvic seat belt 404. In a particular embodiment, the two point pelvic seat belt 404 secures at points 408, 410 on opposite sides of the upper base 16. The two point seat belt 404 having a third and/or fourth point of attachment receiving portion 406 at one or more locations along the seat belt 404 configured to receive a third point of attachment from a vehicle, the third point of attachment carried by the vehicle (not shown).

At least a portion of the support assembly 266 defines a seat 22. The seat 22 is convertible between an examination table by lowering a back portion 34 and raising a leg portion 36 to be substantially in line with a seat portion 23, as depicted in FIG. 3, and a seated position by raising the back portion 34 and lowering the leg portion 36, as depicted in FIG. 2. Rubber stoppers 412 are placed about the upper base 16 for preventing mental on metal contact when the device 10 is positioned with the upper frame 272 is in a lowered position, as illustrated in FIG. 3.

One or more buttons, such as the valve control member 304, carried by the device 10, pushed in a first direction allow for a hydraulic and/or gas shock assembly 50 to slideably move for positioning the back portion 34 and/or the leg portion 36.

The examination table is optionally raised and lowered vertically in substantially the direction along Line A (shown in FIG. 4) via the hydraulic foot action pump lever 17. In operation, an operator, including a doctor or other medical care professional performing an examination on a patient may raise and lower the chair for the desired height to examine a patient thereon.

Optional retractable stirrups (not shown) may be provided coupled to the device 10 for performing gynecological examinations herewith, as would be commonly understood by a skilled artisan.

In an embodiment the mechanism that raises the chair is independent of the mechanism(s) that raise and lower the back portion 34 and the leg portion 36. In an embodiment, a secondary control allows for lowering the chair from a raised position.

The device 10 includes a handle 38 for pushing/pulling device 10 on a surface below the wheels.

The scissor lift portion 14 is secured at pivot portions 3088, 3092, 3094, 3098 and slides along a track as described in more detail herein, as illustrated in FIGS. 2 & 4.

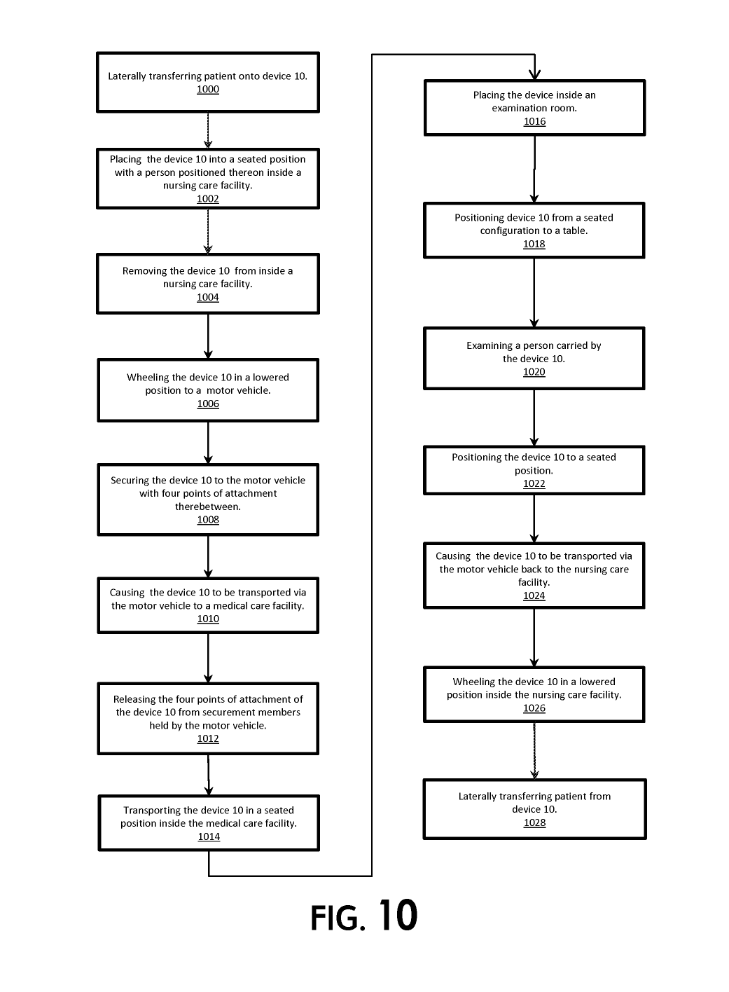

Referring now to FIG. 10, a process for transporting a mobile transportation device convertible to an examination table between a living facility and a medical facility is illustrated. In some cases, elderly patients are bed ridden. Accordingly, at block 1000, a patient is laterally transferred from a bed to the device 10. In one embodiment, the device 10 is in a reclined position to allow for the ease of lateral transfer. A user may adjust the height of the device 10 via the foot pump to allow for optimal height while laterally transferring the patient.

If the device 10 is placed in a reclined position such that the patient positioned thereon may be in a supine or semi-supine position, a person will then place the device 10 in a lowered seated position for transportation, as represented in an exemplary process block 1002. Once in a seated position with the back of the device 10 raised, a person may remove the device with another person thereon the device 10 from inside a living facility by pushing the handle 38, as represented by block 1004. The process includes transporting and/or wheeling the device 10 carrying a person from inside a nursing care facility to a motor vehicle, as represented by block 1006. Once the device 10 has been wheeled to the motor vehicle, the device 10 is loaded into the motor vehicle by conventional means. For example, the device 10 may be lifted via a wheelchair lift assembly attached with the motor vehicle or pushed up a vehicle ramp. The device 10 is secured to the motor vehicle via a tie down link system that connects to the four tie down links 18 to reduce injuries during transportation from significant movement of the device 10 during a traffic accident, as represented by block 1008. In one embodiment, the tie down link system includes ratchet tie down straps (or other tie down straps) that secure between the tie down links 18 and the motor vehicle to secure the device 10 substantially in place inside the motor vehicle during transportation. The tie down straps may include hooks or other grasping members, that grasp the tie down links 18 for causing a secure connection between the device 10 and the motor vehicle. In one non-limiting embodiment and prior to the motor vehicle's departure, the crash safety bar 310 is positioned with the device 10 as further disclosed herein to increase the structural integrity of the device 10 during transportation in a motor vehicle.

A person will transport the device 10 to a medical care facility, such as a doctor's office, as represented by block 1010. A person will free the device 10 from the motor vehicle by releasing securement members, such as the ratchet tie-downs, from the four tie down links 18, as represented by block 1012. The device 10 is wheeled in a seated position inside the medical care facility, as represented by block 1014. Alternatively, the device 10 may be positioned into a reclined position.

When appropriate and at a period of time after arriving at the medical care facility, the crash safety bar 310 is released or otherwise removed from the device 10 for allowing the device 10 to transition to an examination table.

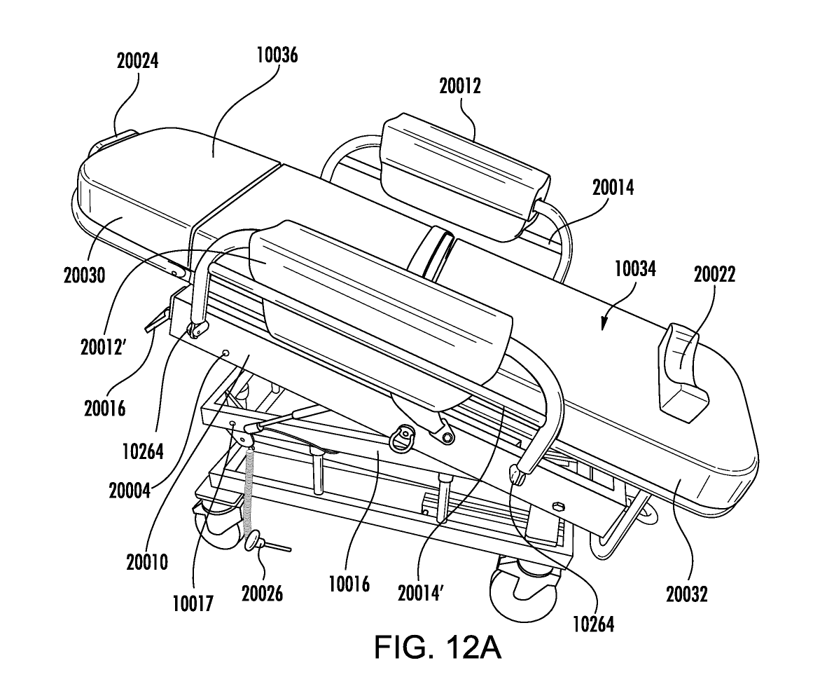

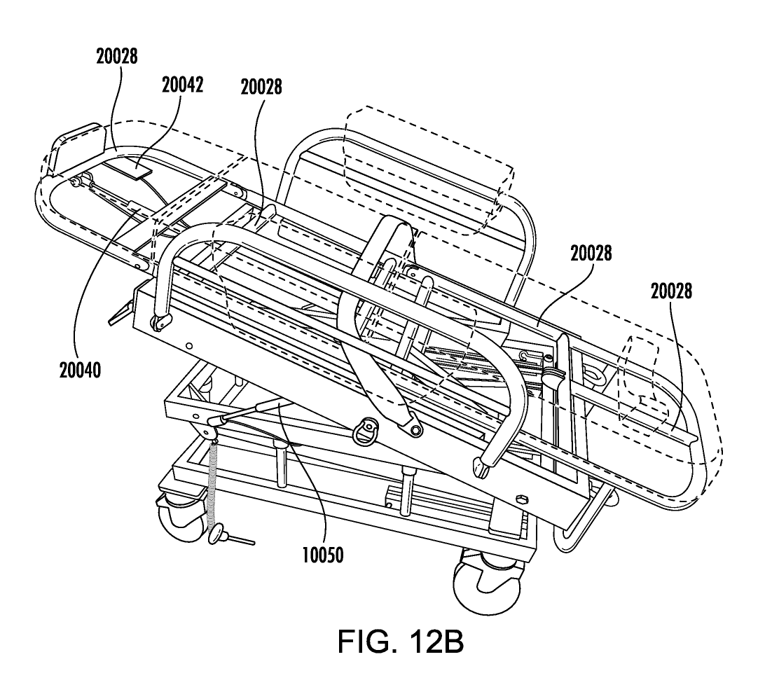

At block 1016, a person rolls the device 10 into an examination room at the medical care facility. Once placed into an examination room, the device 10 is positioned from a seated configuration to a table, which includes without limitation an examination table and/or a Trendelenburg table, as represented by block 1018. As a Trendelenburg table, the leg receiving portion should be raised to a height above the back receiving portion, as exemplified by FIG. 12A. In preparing the patient to be examined, the device 10 is brought from a seated position to reclined position including raising the lower leg receiving portion and lowering the back receiving portion whereby the device 10 is positioned to a desired reclined position, including a flat position, as illustrated in FIG. 3, or otherwise reclined between 90 degrees and 180 degrees as desired. In further preparing the device 10 for facilitating a medical examination, the locking mechanism 113 placed into a locked position for preventing the wheels 20 from moving about the ground surface during the examination. Further, the scissor lift assembly 121 will raise the device 10 via actuation of the foot action pump lever 17 for examining the person positioned thereon the device 10 at a desired height. More particularly, a person, including without limitation the doctor or other health care professional, may raise and lower the device 10 to the optimal height for examining the person thereon by pumping on the foot action pump lever 17 and rotating the valve lever 216. Once in the desired configuration, a medical care professional will examine a person carried by the device 10, as represented by block 1020.

After the examination, the device 10 is returned to a seated position, as represented by block 1022. When appropriate, the valve lever 216 is rotated for lowering the upper base 16 thereby placing the device 10 in a lowered position. A person will return the back portion to an upright seated position and the locking mechanism for the wheel is released, which allows for a person to push the device 10 via the handle 38.

A person will push the device back to the motor vehicle. At which time, the device 10 is loaded into the vehicle and secured via one or more securement members carried by the vehicle. The device 10 is secured via four points of attachment. The device 10 may be secured at its four points of attachment via on or more tie down straps. When appropriate, the crash safety bar 310 is positioned with the device 10 for maintaining the structural integrity of the back portion during transportation of the device 10 back to the nursing care facility. The wheel locking mechanism 113 is engaged to prevent the device 10 from further moving about the motor vehicle. A person will transport the device 10 back to the nursing care facility, as represented by block 1024. The device 10 is wheeled back into the living facility, as represented by block 1026. The device 10 may be wheeled in either a reclined position or in a seated position.

At block 2028, the patient is laterally transferred to a bed or other structure. Alternatively, the patient may be left on the device 10 inside the living facility.

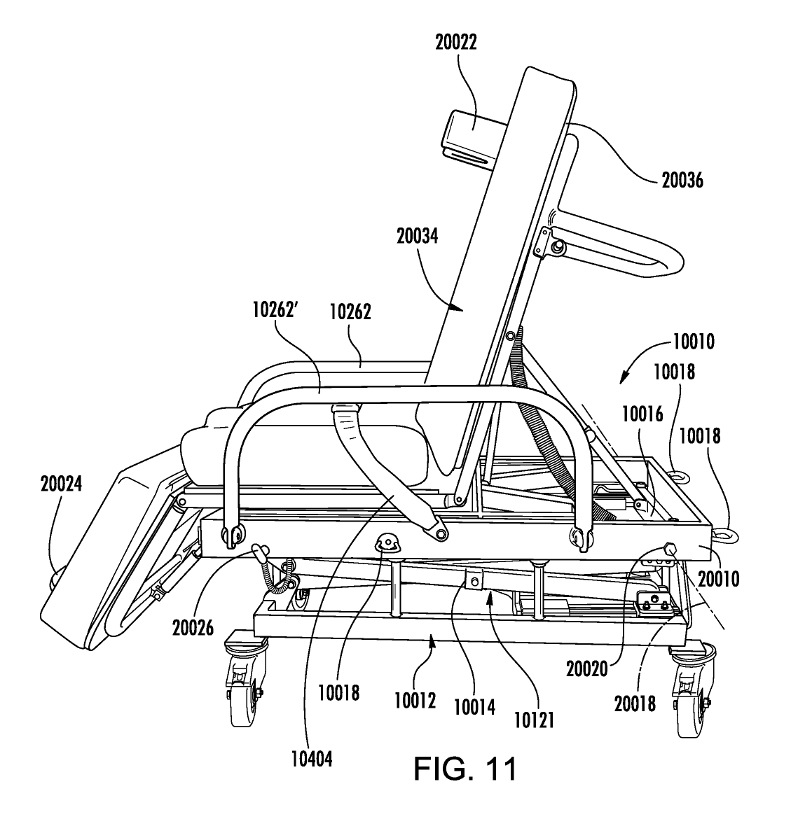

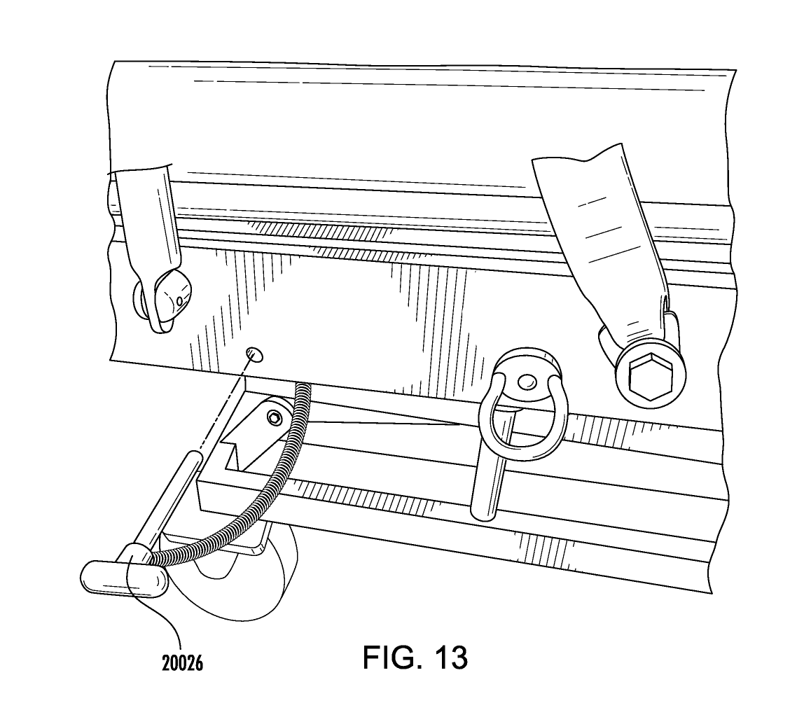

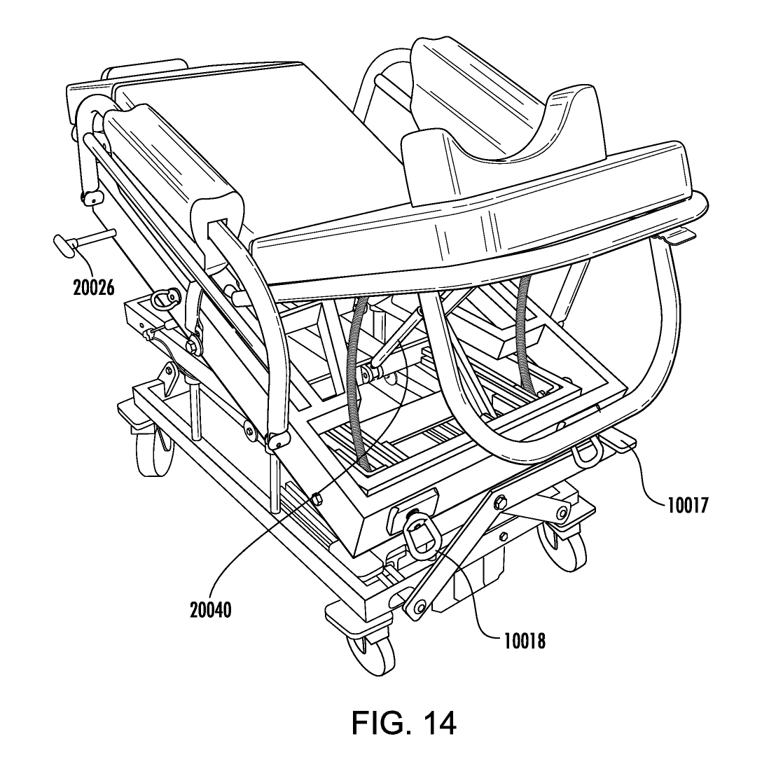

Now referring to FIGS. 11-14, is shown an alternative but similar embodiment of the invention discussed above in FIGS. 1-9, wherein the instant embodiment teaches the implementation of a Transdelenburg device 10010. Device 10010 comprises a lower base 10012, an upper base 10016, and a scissor lift assembly 10121. The lower base 10012 carries the scissor lift assembly 10121 and the upper base 10016. The scissor lift assembly 10121 has a scissor lift portion 10014 configured to raise and lower the upper base 10016 via a hydraulic foot action pump lever 10017 (see FIG. 14) that controls a hydraulic pump within the spirit and scope of the instant invention.

The upper base 10016 carries a Trendelenburg frame 20010. The Trendelenburg frame 20010 carries one or more tie down links 10018, the tie down links couple with tie down members (not shown) for securing the device 10010 in and to the motor vehicle. The tie down members may include for example ratchet tie downs as is commonly understood. In an embodiment, two rear tie down links 10018 are secured at the rear of the device 10010. The two rear tie down links 10018 are carried by the upper base 10016. Two side tie down links 10018 are carried by the device 10010 between the rails 10262, 10262′. In a particular configuration, the two side tie down links 10018 are carried on Trendelenburg frame 20010. The tie down links extend out laterally from the Trendelenburg frame 20010.

Still referring to FIG. 11, the Trendelenburg frame 20010 carries rails 10262, 10262′ and/or guards, on each of the right and left side of the device 10010 respectively. The rails 10262, 10262′ are configured to carry arm rests 20012, 20012′ and may be constructed and arranged specifically for dialysis treatment/procedures/examinations. In one embodiment, each of the guards 10262, 10262′ include an additional bar 20014, 20014′ that operates to prevent the arm rests from spilling about the rails 10262, 10262′. One or more rail joints 10264 are secured about the Trendelenburg frame 20010 for pivotably coupling the rails 10262, 10262′ to the Trendelenburg frame 20010. Operatively, the rails 10262, 10262′ pivot at least 180 degrees between an engaged position and a disengaged position (FIG. 4 illustrates a left rail 10262′ in an engaged position and a right rail 10262 in a disengaged position). Operatively, the user can lift the rails 10262, 10262′ at least slightly upwards, which releases the rails from the engaged position for pivoting the rails to the 180 degree disengaged position.

In operation, the Trendelenburg frame 20010 transitions between a neutral position shown in FIG. 11, and an declined Trendelenburg position shown 12A. A Trendelenburg pivot axis 20018 maintains an axis about which the Trendelenburg frame 20010 rotates between the neutral and declined positions. In the instant embodiment, two Trendelenburg bolts 20020 maintain the pivotal relation of Trendeleberg pivot axis 20018 between the Trendelenburg frame 20010 and the upper base 10016.

In one operation of the embodiment shown, one or more buttons, such as valve control member 20016, carried by device 10010, when actuated allows for a hydraulic and/or gas shock assembly 10050 to slideably move for positioning a back portion 10034 and/or a leg portion 10036, particularly for positioning the device 10010 into a Trendelenburg position such as the Trendelenburg position shown in FIG. 12a. The one or more assemblies 10050 are disposed between the Trendelenburg Frame 20010 and the upper base 16.

One or more Trendelenburg pins 20026 may be inserted and/or removed from one or both of the upper base 10016 and the Trendelenburg frame 20010 via frame apertures 10017, 20011 for allowing the Trendelenburg frame 20010 to transition between the neutral and Trendelenburg positions. When one or more of the Trandelenburg pins 20026 are engaged, the Trendelenburg frame 20010 is locked positionally in relation to the upper base 10016 and cannot rotate about the Trendelenburg axis 20018. For example, FIG. 11 depicts a Trendelenburg pin 20026 engaged with both of the upper base 10016 and the Trendelenburg frame 20010. And for another example, FIG. 12A depicts the Trendelenburg pin disengaged from both of the upper base 1016 and the Trendelenburg frame 20010.

As shown in FIG. 12B, a cushion frame 20028 is show. The cushion frame 20028 is disposed about the Trendelenburg frame 20010. The cushion frame 20028 may be positioned between a seated position such as that illustrated by FIG. 11 and a flat position as illustrated in FIG. 12B (in FIG. 12B a flat Trendelenburg position is illustrated). One or more hydraulic and/or gas shocks 20040 may be implemented connected between the cushion frame and the Trendelenburg frame for maintaining the cushion frame in a position, such as the seated position, and implemented within the spirit and scope of the instant invention. One or more actuating device 20042 are implemented for allowing the hydraulic and/or gas shocks 20040 to operate in transitioning the cushion frame between a seated position and a flat position. The leg portion 20030 and the back portion 20032 in one embodiment moves independent of one another. In other embodiment, the leg portion 20030 and the back portion 20032 move in unison or in relation to one another.

In the embodiment shown in FIG. 11, a cushion assembly 20034 is provided for a person to sit or lie on. In one embodiment, one or more cushion support members 20036 sandwich between the cushion frame 20028 and the cushion assembly 20034.

The back portion includes a head/neck rest 20022 that helps support and maintain the patient about the device 10010 when in the Trendelenburg position.

The device 10010 includes a footrest 20024 coupled with the cushion frame 20028, the footrest 20024 configured to receive and support a patients feet thereon.

In an embodiment, the device 10010 carries a two point pelvic seat belt 10404 (See FIG. 11). In a particular embodiment, the two point pelvic seat belt 10404 secures at points on opposite sides of the Trendelenburg frame 20010. The two point seat belt 10404 having a third and/or fourth point of attachment receiving portion at one or more locations along the seat belt 10404 configured to receive a third point of attachment from a vehicle, the third point of attachment carried by the vehicle (not shown).

The invention disclosed herein may be made in any conventional manner. Parts from the various embodiments may be joined together in any well known manner to a person skilled in the art or that would allow.

Many of the parts used herein are formed of metal. Many of the metal parts used herein may optionally be formed of anodized aluminum.

As used herein, when the term “and/or” is used, it shall include all combinations of one or more of the associated described items.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are contemplated in light of the above teachings without departing from the scope and spirit of the invention. It will be readily apparent that various changes may be made thereto without departing from the spirit and scope of the disclosure or sacrificing all of its material advantages. The examples and embodiments described herein are merely exemplary of the instant disclosure. The various embodiments and features may be combined as desired to arrive at the present invention.

What is claimed is:

1. A transportation device convertible to a Trendelenburg table for supporting a person thereon, the transportation device comprising:
a lower support structure;
a pair of rotatable wheels carried by said support structure;
an upper support structure coupled with said lower support structure;
a lifting structure coupling said upper support structure with said lower support structure;
a Trendelenburg support structure coupled with said upper support structure; and
at least one tie down link secured about the transportation device.

2. The transportation device of claim 1, further comprising at least four of said tie down links.

3. The transportation device of claim 1, further comprising a back portion pivotably coupled in relation to said Trendelenburg support structure.

4. The transportation device of claim 3, further comprising a longitudinally extending crash support member unlockably mountable between a portion of said back portion and said upper support structure.

5. The transportation device of claim 4, wherein said crash support member positionable for maintaining said back portion in at least a substantially upright position.

6. The transportation device of claim 5, wherein said lifting structure having a scissor lifting portion.

7. The transportation device of claim 6, wherein said scissor lifting portion further comprising:
a left outer arm and a left inner arm joined together at an intermediate location, said outer and inner left arms each having a first end and a second end defining four left arm ends, one of said left arm ends pivotably joined with said upper support structure, one of said left arm ends pivotably joined with said lower support structure, one of said left arm ends slidably joined with said lower support structure, one of said left arm ends slidably joined with said upper support structure; and
a right outer arm and a right inner arm joined together at an intermediate location, said outer and inner right arms each having a first end and a second end defining four right arm ends, one of said right arm ends pivotably joined with said upper support structure, one of said right arm ends pivotably joined with said lower support structure, one of said right arm ends slidably joined with said lower support structure, one of said right arm ends slidably joined with said upper support structure.

8. The transportation device of claim 5, further comprising a hydraulic lift assembly carried by said lower support structure.

9. The transportation device of claim 1, further comprising a plurality of posts, said plurality of posts having proximal ends carried by said lower support structure and having distal ends operable to support said upper support structure.

10. The transportation device of claim 1, the transportation device constructed to withstand forces of at least 20 g during a 30 mph crash.

11. A transportable Trendelenburg table comprising:
a transportable structure carrying a plurality of wheels, said transportable structure constructed and arranged to transition between a chair and a Trendelenburg table; and
a plurality of tie down links secured about said transportable structure.

12. The transportable Trendelenburg table of claim 11, wherein said transportable structure configurable to support a patient in a supine position thereon.

13. The transportable Trendelenburg of claim 12, wherein said transportable structure constructed to withstand forces of at least 20 g during a 30 mph crash.

14. The transportable Trendelenburg table of claim 11, the transportable structure defining:
a base defining a lower support structure and an upper support structure, said lower support structure carrying a plurality of wheels, said upper support structure defining a Trendelenburg portion capable of transitioning between a seat and a Trendelenburg table;
a support portion carried by said upper support structure;
at least one tie down receiving portion provided about said transportable structure.
wherein said support portion convertible between said chair and said Trendelenburg table;

15. The transportable Trendelenburg table of claim 14 wherein said base constructed to withstand forces of at least 20 g during a 30 mph crash.

16. The transportable Trendelenburg table of claim 15 further comprising a safety arm removably couplable between said base and said support portion.

17. The transportable Trendelenburg table of claim 15 further comprising a plurality of links configured to join said lower support structure with said upper support structure when said scissor lifting structure positioned in a collapsed position.

18. A method of transporting a Trendelenburg table between a first location and a second location, the method comprising:
placing the Trendelenburg table in a lowered seated position;
securing the Trendelenburg table in a motor vehicle via at least one tie down receiving portions;
transporting the Trendelenburg table between the first location and a second location;
positioning the Trendelenburg table between a seated position and a Trendelenburg position;
returning the Trendelenburg table to a seated position;
securing the Trendelenburg table in a motor vehicle via the at least one tie down receiving portions; and
transporting the Trendelenburg table between said second location and said first location.

19. The method of claim 18 wherein after positioning the examination table between a seated position and a Trendelenburg position further comprising the process of allowing dialysis of a patient thereon.

20. The method of claim 18 further comprising the process of securing a back support member with the Trendelenburg table in the seated position during transportation between the first and second location.
